(19) United States
(12) Patent Application Publication
(10) Pub. No.: US 2013/0242827 A1
(43) Pub. Date: Sep. 19, 2013

(54) METHODS AND APPARATUSES FOR FACILITATING UPLINK MULTIPLE INPUT MULTIPLE OUTPUT SIGNALING

(71) Applicants: Karl Marko Juhani Lampinen, Oulu (FI); Arto Johannes Lehti, Oulu (FI); Tao Chen, Espoo (FI)

(72) Inventors: Karl Marko Juhani Lampinen, Oulu (FI); Arto Johannes Lehti, Oulu (FI); Tao Chen, Espoo (FI)

(73) Assignee: RENESAS MOBILE CORPORATION, Chiyoda-ku (JP)

(21) Appl. No.: 13/451,023

(22) Filed: Apr. 19, 2012

(30) Foreign Application Priority Data
Mar. 19, 2012 (GB) 1204774.2

(51) Int. Cl. H04W 52/02; H04W 72/04

(52) U.S. Cl. 370/311; 370/329

(57) ABSTRACT

A method, apparatus and computer program product are provided for detecting multiple input multiple output communications. A method and apparatus may enable transmission of a first control signal to a communication device. The first control signal may indicate at least one number of data streams that the communication device is allowed to utilize to transmit data. The method and apparatus may perform detection of discontinuous transmission on one or more control channels indicated by the first control signal. The method and apparatus may determine whether the communication device currently communicates on the control channels in response to performing the detection of the discontinuous transmission.

### CROSS-REFERENCE TO RELATED APPLICATIONS

This application claims priority to Great Britain (GB) Application No. 1204774.2 filed Mar. 19, 2012 which is hereby incorporated herein in its entirety by reference.

### TECHNOLOGICAL FIELD

Embodiments of the present invention relate generally to wireless communications technology and, more particularly, to a method and apparatus for facilitating uplink multiple input multiple output signaling in a communications system.

### BACKGROUND

Currently, uplink multiple input and multiple output (MIMO) communications for high-speed uplink packet access (HSUPA) is being standardized for the third generation partnership project (3GPP). In this manner, a dual stream MIMO solution for HSUPA is provided. At present, there is support for closed loop transmit diversity in the 3GPP specifications and as such MIMO may add support to dual data stream transmissions on top of the existing closed loop transmit diversity design. Future evolution of MIMO transmission may use transmission of more than two streams.

The HSUPA introduces new channels at a physical layer. For example, the HSUPA system has an Enhanced Dedicated Physical Control Channel (E-DPCCH) in uplink which typically carries information on the Enhanced Transport Format Combination Indicator (E-TFCI) and other information related to the Enhanced Dedicated Physical Data Channel (E-DPDCH). Additionally, the E-DPCCH is used to carry the control information. The E-DPDCH may be used to carry data which includes information associated with an Enhanced Dedicated Channel (E-DCH) Transport Channel, etc. HSUPA may utilize two E-DPCCHs, one for a primary data stream and the other one for the secondary data stream. Similarly, in the uplink dual stream MIMO transmission HSUPA system there may be several E-DPDCHs. For example, E-DPDCHs that are transmitted using a primary precoding vector i.e., in the primary data stream and E-DPDCHs that are transmitted using a secondary precoding vector i.e., in the secondary stream.

HSUPA typically uses a packet scheduler meaning that a base station (e.g., a Node B) decides which User Equipment (UE) is allowed to transmit data and how much interference it is allowed to be generated in the network. The scheduling decisions are communicated to the UE by using downlink grant messages. As such, the grant may be understood as an upper limit to what a UE may transmit and the UE may reduce its transmitted data rate or may cease transmission in some instances (e.g., in an instance in which the UE has a small amount of data in a transmit buffer). In an instance in which the UE may cease transmission, the base station may need to perform a discontinuous (DTX) detection to determine that an E-DPCCH(s) is not being transmitted. However, performing DTX detection separately for both E-DPCCH channels in all instances may be inefficient and may waste resources.

### BRIEF SUMMARY

A method, apparatus and computer program product are therefore provided according to an example embodiment in order to provide an efficient and reliable manner for facilitating uplink multiple input multiple output signaling in a communications system. The MIMO communications may relate to high-speed uplink packet access.

The example embodiments may provide an efficient and reliable manner in which to perform a discontinuous detection for two E-DPCCHs in instances in which a dual stream transmission is indicated in downlink signaling information, such as, for example, including the information on the downlink grant provided from a network device (e.g., a Node B) to a communication device (e.g., a UE). In this regard, in response to the communication device receiving the downlink grant indicating a preference for utilizing the dual stream transmission, the communication device may transmit with a single data stream or a dual data stream. In one example embodiment, the downlink signaling information may include but is not limited to a first control signal.

In instances in which the communication device transmits with the single data stream and the downlink grant indicates a preference for dual stream transmission, the communication device may communicate control information on primary and secondary E-DPCCHs. However, the communication device communicates data in one stream enhanced dedicated data channels such as, for example, E-DPDCH(s) in a primary stream. On the other hand, in an instance in which the communication device transmits with the dual data stream and the downlink grant indicates a preference for using the dual stream transmission, the communication device may communicate control information on primary and secondary E-DPCCHs and may communicate data on primary and secondary stream enhanced dedicated data channels such as, for example, E-DPDCHs in primary and secondary streams.

In an instance in which the downlink grant indicates a preference for a single data stream transmission, the communication device may communicate with a single data stream on a primary E-DPCCH and an E-DPDCH(s) in a primary stream.

In one embodiment, a method is provided that includes enabling transmission of a first control signal to a communication device. The first control signal indicates at least one number of data streams that the communication device is allowed to utilize to transmit data. The method of this embodiment also performs detection of discontinuous transmission on one or more control channels indicated by the first control signal. The method of this embodiment also determines whether the communication device currently communicates on the control channels in response to performing the detection of discontinuous transmission.

In another embodiment, an apparatus is provided that includes at least one processor and at least one memory including computer program code with the at least one memory and the computer program code being configured to, with the processor, cause the apparatus to at least enable transmission of a first control signal to a communication device. The first control signal indicates at least one number of data streams that the communication device is allowed to utilize to transmit data. The at least one memory and the computer program code of this embodiment are also configured to, with the processor, cause the apparatus to perform detection of discontinuous transmission on one or more control channels indicated by the first control signal. The at least one memory and the computer program code of this embodiment are also configured to, with the processor, cause the apparatus to determine whether the communication device currently communicates on the control channels in response to performing the discontinuous transmission.

In a further embodiment, a computer program product is provided that includes at least one non-transitory computer-readable storage medium having computer-readable program instructions stored therein with the computer-readable program instructions including program instructions configured to enable transmission of a first control signal to a communication device. The first control signal indicates at least one number of data streams that the communication device is allowed to utilize to transmit data. The computer-readable program instructions of this embodiment also include program instructions configured to perform detection of discontinuous transmission on one or more control channels indicated by the first control signal. The computer-readable program instructions of this embodiment also include program instructions configured to determine whether the communication device currently communicates on the control channels in response to performing the discontinuous transmission.

In yet another embodiment, an apparatus is provided that includes means for enabling transmission of a first control signal to a communication device. The first control signal indicates at least one number of data streams that the communication device is allowed to utilize to transmit data. The apparatus of this embodiment also includes means for performing detection of discontinuous transmission on one or more control channels indicated by the first control signal. The apparatus of this embodiment also includes determining whether the communication device currently communicates on the control channels in response to performing the discontinuous transmission.

In one embodiment, a method is provided that includes receiving a first control signal from a network device. The first control signal indicates at least one number of data streams that a communication device is allowed to utilize to transmit data. The method of this embodiment also includes enabling transmission of a single data stream or a dual data stream to the network device based in part on information of the first control signal. The method also includes enabling transmission of data on one or more control channels based in part on the information of the first control signal.

In another embodiment, an apparatus is provided that includes at least one processor and at least one memory including computer program code with the at least one memory and the computer program code being configured to, with the processor, cause the apparatus to at least receive a first control signal from a network device. The first control signal indicates at least one number of data streams that a communication device is allowed to utilize to transmit data. The at least one memory and the computer program code of this embodiment are also configured to, with the processor, cause the apparatus to enable transmission of a single data stream or a dual data stream to the network device based in part on information of the first control signal. The at least one memory and the computer program code of this embodiment are also configured to, with the processor, cause the apparatus to enable transmission of data on one or more control channels based in part on the information of the first control signal.

In yet another embodiment, a computer program product is provided that includes at least one non-transitory computer-readable storage medium having computer-readable program instructions stored therein with the computer-readable program instructions including program instructions configured to cause receipt of a first control signal from a network device. The first control signal indicates at least one number of data streams that a communication device is allowed to utilize to transmit data. The at least one memory and the computer program code of this embodiment are also configured to, with the processor, cause the apparatus to enable transmission of a single data stream or a dual data stream to the network device based in part on information of the first control signal. The at least one memory and the computer program code of this embodiment are also configured to, with the processor, cause the apparatus to enable transmission of data on one or more control channels based in part on the information of the first control signal.

In a further embodiment, an apparatus is provided that includes means for receiving a first control signal from a network device. The first control signal indicates at least one number of data streams that a communication device is allowed to utilize to transmit data. The apparatus of this embodiment also includes means for enabling transmission of a single data stream or a dual data stream to the network device based in part on information of the first control signal. The apparatus of this embodiment also includes means for enabling transmission of data on one or more control channels based in part on the information of the first control signal.

### BRIEF DESCRIPTION OF THE SEVERAL VIEWS OF THE DRAWINGS

Having thus described the invention in general terms, reference will now be made to the accompanying drawings, which are not necessarily drawn to scale, and wherein:

FIG. 1 is a schematic representation of a system that may benefit from an example embodiment;

FIG. 2 is a schematic block diagram of an apparatus from the perspective of a base station in accordance with an example embodiment;

FIG. 3 is a block diagram of an apparatus that may be embodied by a mobile terminal in accordance with an example embodiment;

FIG. 4 is a diagram illustrating operations performed in accordance with one example embodiment;

FIGS. 5A, 5B and 5C are diagrams illustrating single data stream and dual data stream E-DPCCH formats according to an example embodiment;

FIG. 6 is a flowchart illustrating operations performed in accordance with one example embodiment; and

FIG. 7 is a flowchart of operations performed in accordance with another example embodiment.

### DETAILED DESCRIPTION

The present invention now will be described more fully hereinafter with reference to the accompanying drawings, in which some, but not all embodiments of the inventions are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

As used in this application, the term ‘circuitry’ refers to all of the following: (a) hardware-only circuit implementations (such as implementations in only analog and/or digital circuitry) and (b) to combinations of circuits and software (and/or firmware), such as (as applicable): (i) to a combination of processor(s) or (ii) to portions of processor(s)/software (including digital signal processor(s)), software, and memory(ies) that work together to cause an apparatus, such as a mobile phone or server, to perform various functions) and (c) to circuits, such as a microprocessor(s) or a portion of a microprocessor(s), that require software or firmware for operation, even if the software or firmware is not physically present.

This definition of ‘circuitry’ applies to all uses of this term in this application, including in any claims. As a further example, as used in this application, the term “circuitry” would also cover an implementation of merely a processor (or multiple processors) or portion of a processor and its (or their) accompanying software and/or firmware. The term “circuitry” would also cover, for example and if applicable to the particular claim element, a baseband integrated circuit or application specific integrated circuit for a mobile phone or a similar integrated circuit in server, a cellular network device, or other network device.

As defined herein a “computer-readable storage medium,” which refers to a non-transitory, physical or tangible storage medium (e.g., volatile or non-volatile memory device), may be differentiated from a “computer-readable transmission medium,” which refers to an electromagnetic signal.

As referred to herein, a happy bit(s) may denote a single bit field that is passed from a media access control (MAC) to a physical layer for inclusion on the E-DPCCH. This field may takes two values, such as “Not Happy” and “Happy” indicating respectively whether a UE may use more resources for E-DCH data transmission or not. A happy bit may be set to “unhappy” in an instance in which: (1) a UE is transmitting as much scheduled data as allowed by a current serving grant; (2) a UE has enough power available to transmit at higher data rate; (3) a UE has enough data in a transmit buffer such that transmission of the data may take longer than the time period defined by a parameter (e.g., a Happy_Bit_Delay_Condition parameter); (4) or any other suitable criteria.

As referred to herein, a grant, serving grant, downlink grant or other similar terms may be referred to herein interchangeably to denote relative power or amplitude of an E-DPDCH (e.g., a HSUPA data channel) that a Node B may allow a UE to utilize for data transmission. A serving grant (e.g., a first control signal) may be generated and signaled by a Node B in a downlink. In an example embodiment, a number of streams a UE is allowed to transmit may be included as part of a downlink grant signaling. In this regard, the downlink grant may include data indicating the number of streams that the Node B signals is the maximum that the UE is allowed to use. In an instance in which a dual stream transmission is granted by the Node B, the UE may choose to transmit a dual stream or a single stream. For purposes of illustration and not of limitation, in an instance in which the UE does not have enough data in a transmit buffer to use a dual stream, the UE may transmit a single stream. Although the maximum number of streams is described above as part of the downlink grant, as an example, any other suitable mechanisms of signaling the maximum allowed number of streams in downlink may also be utilized in addition to a grant message.

A maximum usage of resources may be signaled using the downlink grant, and as such it may be assumed that the grant in the MIMO communications also indicates the maximum number of transmitted MIMO streams. In an instance in which a base station (e.g., node B) signals a grant indicating a maximum of dual stream transmission, a UE may still choose to transmit only one stream (e.g., a rank 1 transmission). The ability of a UE to choose to transmit only one stream in response to the base station signaling a grant indicating a dual stream transmission coupled with the incremental E-DPCCH design may signify that the base station needs to perform DTX detection for both E-DPCCH channels. DTX detection may be done by thresholding a received power level. Performing DTX detection separately for both E-DPCCH channels in all instances may be inefficient and may waste resources.

In view of the foregoing drawbacks, it may be beneficial to provide a more efficient and reliable mechanism of performing a DTX detection for the E-DPCCH for all streams.

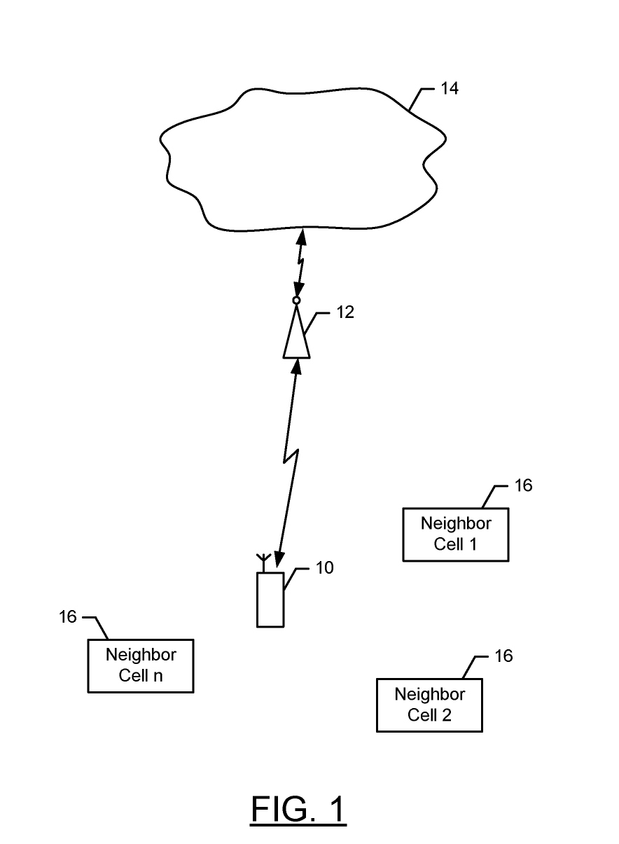

Referring now to FIG. 1, a system according to an example embodiment is provided. The system of FIG. 1 includes a first communication device (e.g., mobile terminal 10) that is capable of communication via a serving cell 12, such as a base station, a Node B, an evolved Node B (eNB), a radio network controller (RNC) or other access point, with a network 14 (e.g., a core network). While the network may be configured in accordance with Universal Mobile Telecommunications System (UMTS), Long Term Evolution (LTE) or LTE-Advanced (LTE-A), other networks may support the method, apparatus and computer program product of embodiments of the present invention including those configured in accordance with wideband code division multiple access (W-CDMA), CDMA2000, global system for mobile communications (GSM), general packet radio service (GPRS) and/or the like.

The network 14 may include a collection of various different nodes, devices or functions that may be in communication with each other via corresponding wired and/or wireless interfaces. For example, the network may include one or more cells, including serving cell 12 and one or more neighbor cells 16 (designated neighbor cell 1, neighbor cell 2, . . . neighbor cell n in the embodiment of FIG. 1), each of which may serve a respective coverage area. The serving cell and the neighbor cells could be, for example, part of one or more cellular or mobile networks or public land mobile networks (PLMNs). In turn, other devices such as processing devices (e.g., personal computers, server computers or the like) may be coupled to the mobile terminal 10 and/or other communication devices via the network.

A communication device, such as the mobile terminal 10 (also referred to herein as User Equipment (UE) 10), may be in communication with other communication devices or other devices via the serving cell 12 and, in turn, the network 14. In some cases, the communication device may include an antenna for transmitting signals to and for receiving signals from a serving cell.

In some example embodiments, the mobile terminal 10 may be a mobile communication device such as, for example, a mobile telephone, portable digital assistant (PDA), pager, laptop computer, or any of numerous other hand held or portable communication devices, computation devices, content generation devices, content consumption devices, or combinations thereof. As such, the mobile terminal 10 may include one or more processors that may define processing circuitry either alone or in combination with one or more memories. The processing circuitry may utilize instructions stored in the memory to cause the mobile terminal 10 to operate in a particular way or execute specific functionality when the instructions are executed by the one or more processors. The mobile terminal 10 may also include communication circuitry and corresponding hardware/software to enable communication with other devices and/or the network 14.

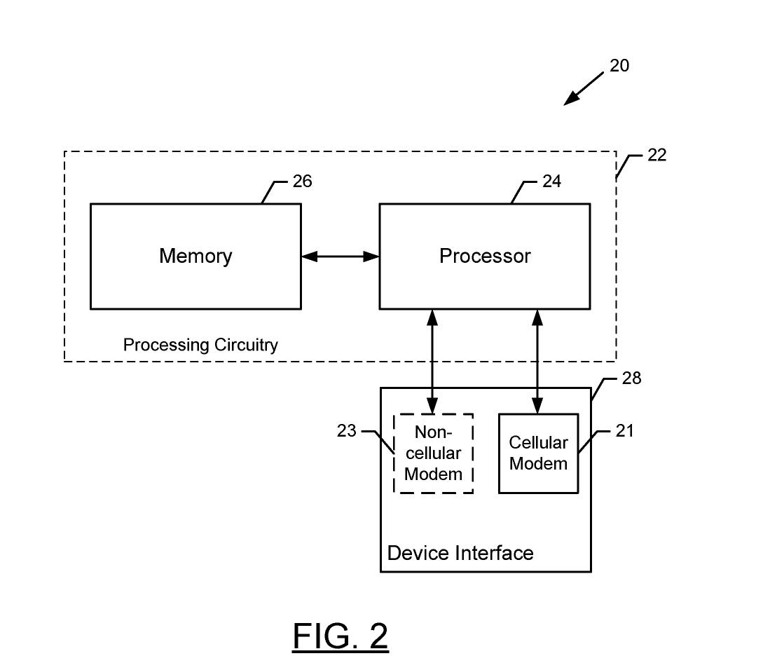

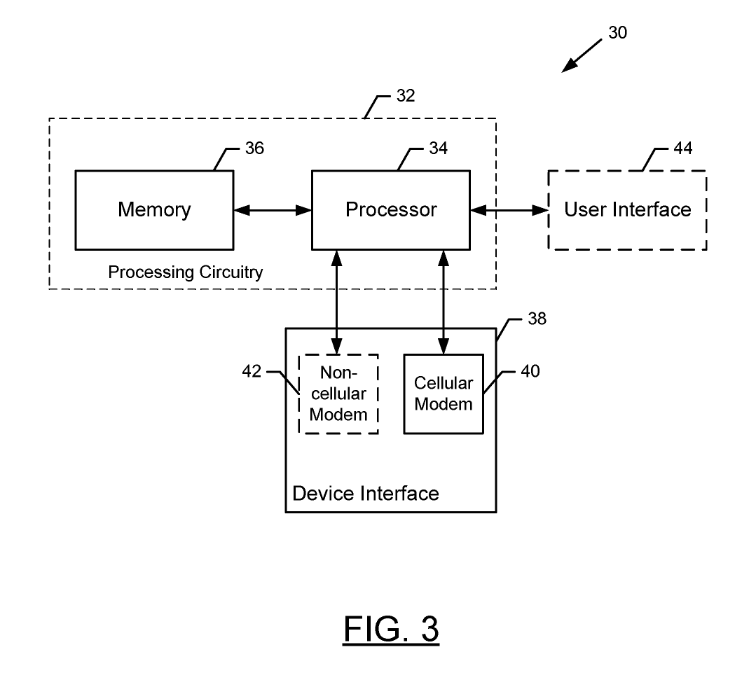

In one embodiment, for example, a neighbor cell 16 and/or the serving cell 12 (also referred to herein as Node B 12) may be embodied as or otherwise include an apparatus 20 as generically represented by the block diagram of FIG. 2. Additionally, in one example embodiment, the mobile terminal 10 may be embodied as or otherwise include an apparatus 30 as generically represented by the block diagram of FIG. 3. While the apparatus 20 may be employed, for example, by a serving cell 12, or a neighbor cell 16 and the apparatus 30 may be employed, for example, by a mobile terminal 10, it should be noted that the components, devices or elements described below may not be mandatory and thus some may be omitted in certain embodiments. Additionally, some embodiments may include further or different components, devices or elements beyond those shown and described herein.

As shown in FIG. 2, the apparatus 20 may include or otherwise be in communication with a processing system including, for example, processing circuitry 22 that is configurable to perform actions in accordance with example embodiments described herein. The processing circuitry may be configured to perform data processing, application execution and/or other processing and management services according to an example embodiment of the invention. In some example embodiments, the apparatus or the processing circuitry may be embodied as a chip or chip set. In other words, the apparatus or the processing circuitry may comprise one or more physical packages (e.g., chips) including materials, components and/or wires on a structural assembly (e.g., a baseboard). The structural assembly may provide physical strength, conservation of size, and/or limitation of electrical interaction for component circuitry included thereon. The apparatus or the processing circuitry may therefore, in some cases, be configured to implement an embodiment of the present invention on a single chip or as a single “system on a chip.” As such, in some cases, a chip or chipset may constitute means for performing one or more operations for providing the functionalities described herein.

In an example embodiment, the processing circuitry 22 may include a processor 24 and memory 26 that may be in communication with or otherwise control a device interface 28. As such, the processing circuitry may be embodied as a circuit chip (e.g., an integrated circuit chip) configured (e.g., with hardware, software or a combination of hardware and software) to perform operations described herein in relation to the apparatus 20. In an alternative example embodiment, the processing circuitry 22 may be embodied in a modem (e.g., cellular modem 21).

The device interface 28 may include one or more interface mechanisms for enabling communication with other devices, such as one or more mobile terminals 10. In some cases, the device interface may be any means such as a device or circuitry embodied in either hardware, or a combination of hardware and software that is configured to receive and/or transmit data from/to a network and/or any other device or module in communication with the processing circuitry 22. In this regard, the device interface may include, for example, an antenna (or multiple antennas) and supporting hardware and/or software for enabling communications with a wireless communication network and/or a communication modem, such as a cellular modem 21 (e.g., a UMTS modem, a LTE modem, etc.), and/or an optional non-cellular modem 23 (e.g., a WiFi modem, WLAN modem, etc.) for enabling communications with other terminals (e.g., WiFi terminals, WLAN terminals, APs, etc).

In an example embodiment, the memory 26 may include one or more non-transitory memory devices such as, for example, volatile and/or non-volatile memory that may be either fixed or removable. The memory may be configured to store information, data, applications, instructions or the like for enabling the apparatus 20 to carry out various functions in accordance with example embodiments of the present invention. For example, the memory could be configured to buffer input data for processing by the processor 24. Additionally or alternatively, the memory could be configured to store instructions for execution by the processor. As yet another alternative, the memory may include one of a plurality of databases that may store a variety of files, contents or data sets. Among the contents of the memory, applications may be stored for execution by the processor in order to carry out the functionality associated with each respective application. In some cases, the memory may be in communication with the processor via a bus for passing information among components of the apparatus.

The processor 24 may be embodied in a number of different ways. For example, the processor may be embodied as various processing means such as one or more of a microprocessor or other processing element, a coprocessor, a controller or various other computing or processing devices including integrated circuits such as, for example, an ASIC (application specific integrated circuit), an FPGA (field programmable gate array), or the like. In an example embodiment, the processor may be configured to execute instructions stored in the memory 26 or otherwise accessible to the processor. As such, whether configured by hardware or by a combination of hardware and software, the processor may represent an entity (e.g., physically embodied in circuitry—in the form of processing circuitry 22) capable of performing operations according to embodiments of the present invention while configured accordingly. Thus, for example, when the processor is embodied as an ASIC, FPGA or the like, the processor may be specifically configured hardware for conducting the operations described herein. Alternatively, as another example, when the processor is embodied as an executor of software instructions, the instructions may specifically configure the processor to perform the operations described herein.

In one embodiment, the mobile terminals 10 may be embodied as or otherwise include an apparatus 30 as generically represented by the block diagram of FIG. 3. In this regard, the apparatus may be configured to provide for communications with the Node B 12 or another terminal(s) via communications system (e.g., a UMTS). While the apparatus may be employed, for example, by a mobile terminal, it should be noted that the components, devices or elements described below may not be mandatory and thus some may be omitted in certain embodiments. Additionally, some embodiments may include further or different components, devices or elements beyond those shown and described herein.

As shown in FIG. 3, the apparatus 30 may include or otherwise be in communication with a processing system including, for example, processing circuitry 32 that is configurable to perform actions in accordance with example embodiments described herein. The processing circuitry may be configured to perform data processing, application execution and/or other processing and management services according to an example embodiment of the present invention. In some embodiments, the apparatus or the processing circuitry may be embodied as a chip or chip set. In other words, the apparatus or the processing circuitry may comprise one or more physical packages (e.g., chips) including materials, components and/or wires on a structural assembly (e.g., a baseboard). The structural assembly may provide physical strength, conservation of size, and/or limitation of electrical interaction for component circuitry included thereon. The apparatus or the processing circuitry may therefore, in some cases, be configured to implement an embodiment of the present invention on a single chip or as a single “system on a chip.” As such, in some cases, a chip or chipset may constitute means for performing one or more operations for providing the functionalities described herein.

In an example embodiment, the processing circuitry 32 may include a processor 34 and memory 36 that may be in communication with or otherwise control a device interface 38 and, in some cases, a user interface 44. As such, the processing circuitry may be embodied as a circuit chip (e.g., an integrated circuit chip) configured (e.g., with hardware, software or a combination of hardware and software) to perform operations described herein. However, in some embodiments taken in the context of the mobile terminal, the processing circuitry may be embodied as a portion of a mobile computing device or other mobile terminal. In an alternative example embodiment, the processing circuitry 32 may be embodied in a modem (e.g., cellular modem 40).

The optional user interface 44 may be in communication with the processing circuitry 32 to receive an indication of a user input at the user interface and/or to provide an audible, visual, mechanical or other output to the user. As such, the user interface in the context of a mobile terminal may include, for example, a keyboard, a mouse, a joystick, a display, a touch screen, a microphone, a speaker, and/or other input/output mechanisms.

The device interface 38 may include one or more interface mechanisms for enabling communication with other devices and/or networks. In some cases, the device interface may be any means such as a device or circuitry embodied in either hardware, or a combination of hardware and software that is configured to receive and/or transmit data from/to a network and/or any other device or module in communication with the processing circuitry 32. In this regard, the device interface may include, for example, an antenna (or multiple antennas) and supporting hardware and/or software for enabling communications with a wireless communication network and/or a communication modem or other hardware/software for supporting communication via cable, digital subscriber line (DSL), universal serial bus (USB), Ethernet or other methods. In the illustrated embodiment, for example, the device interface includes a cellular modem 40 (e.g., a UMTS modem, a LTE modem, etc.) for supporting communications with the Node B 12 and an optional non-cellular modem 42 (e.g., a WiFi modem, WLAN modem, Bluetooth (BT) modem, etc.) for supporting communications with other terminals (e.g., a WiFi station(s), a WLAN station(s)), etc.).

In an example embodiment, the memory 36 may include one or more non-transitory memory devices such as, for example, volatile and/or non-volatile memory that may be either fixed or removable. The memory may be configured to store information, data, applications, instructions or the like for enabling the apparatus 30 to carry out various functions in accordance with example embodiments of the present invention. For example, the memory could be configured to buffer input data for processing by the processor 34. Additionally or alternatively, the memory could be configured to store instructions for execution by the processor. As yet another alternative, the memory may include one of a plurality of databases that may store a variety of files, contents or data sets. Among the contents of the memory, applications may be stored for execution by the processor in order to carry out the functionality associated with each respective application. In some cases, the memory may be in communication with the processor via a bus for passing information among components of the apparatus.

The processor 34 may be embodied in a number of different ways. For example, the processor may be embodied as various processing means such as one or more of a microprocessor or other processing element, a coprocessor, a controller or various other computing or processing devices including integrated circuits such as, for example, an ASIC, an FPGA or the like. In an example embodiment, the processor may be configured to execute instructions stored in the memory 36 or otherwise accessible to the processor. As such, whether configured by hardware or by a combination of hardware and software, the processor may represent an entity (e.g., physically embodied in circuitry—in the form of processing circuitry 32) capable of performing operations according to embodiments of the present invention while configured accordingly. Thus, for example, when the processor is embodied as an ASIC, FPGA or the like, the processor may be specifically configured hardware for conducting the operations described herein. Alternatively, as another example, when the processor is embodied as an executor of software instructions, the instructions may specifically configure the processor to perform the operations described herein.

In an example embodiment, one or more new constraint(s) may be set by a granted maximum rank of the Node B 12. In this regard, for example, a UE 10 may be unable to transmit a higher number of streams than a number of streams indicated in downlink grant sent by the Node B 12 to the UE 10. For example, in an instance in which a Node B 12 sends a downlink grant to the UE 10 indicating that UE 10 is to utilize a single stream transmission, the UE 10 may transmit only a single stream on a data channel (e.g., an E-DPDCH). On the other hand, in an instance in which the Node B 12 generates a downlink grant and specifies a dual stream transmission, the UE 10 may transmit either a single data channel (e.g., E-DPDCH) transmission or a dual stream data channel (e.g., E-DPDCH) transmission.

In an instance in which the downlink grant received from a Node B 12 indicates a single stream transmission, the UE 10 may transmit on one primary control channel (e.g., an E-DPCCH) and one primary data channel (e.g., E-DPDCH). However, in an instance in which the downlink grant received from a Node B 12 indicates a dual stream transmission, the UE 10 may transmit on at least two control channels (e.g., primary and secondary E-DPCCHs) and may decide whether to transmit on at least two data channels (e.g., primary and/or secondary E-DPDCHs), as described more fully below.

The procedure for detecting the number of data streams from one or more (e.g., two) control channels (e.g., E-DPCCH channels) using a single DTX detection is as follows. In an instance in which a Node B (e.g., Node B 12) provides a downlink grant to a UE (e.g., UE 10) indicating a preference of a single stream transmission via signaling, the transmission of the UE (e.g., UE 10) may be a single stream transmission. In this regard, a primary control channel (e.g., one primary E-DPCCH) and a primary data channel (e.g., one primary E-DPDCH) may be transmitted by a processor (e.g., processor 34) of the UE (e.g., UE 10). In this regard, the Node B (e.g., Node B 12) may perform DTX detection on the primary control channel (e.g., primary E-DPCCH). However, in this example embodiment, the Node B may not need to perform DTX detection on a secondary control channel (e.g., a secondary E-DPCCH) since the Node B indicated in the downlink grant that the UE should utilize a single stream transmission to communicate with the Node B. As such, the Node B knows that only a single stream transmission can be expected from the UE.

In an instance in which the Node B generates a downlink grant and indicates in the grant a preference for a dual stream transmission via signaling, the UE may subsequently communicate with the Node B via a dual stream transmission. In this regard, the UE may transmit on the primary control channel (e.g., primary E-DPCCH) and the secondary control channel (e.g., a secondary E-DPCCH) as well as the primary data channel (e.g., a primary E-DPDCH) and the secondary data channel (e.g., a secondary E-DPDCH). Since the Node B indicated the preference in the grant provided to the UE to utilize dual stream transmissions, the Node B may know that the UE may transmit on both the primary and secondary control channels (e.g., primary and secondary E-DPCCHs). In this regard, the Node B may perform single DTX detection on both the primary control channel (e.g., primary E-DPCCH) and secondary control channel (e.g., secondary E-DPCCH) jointly. In this regard, the processor (e.g., processor 24) of the Node B (e.g., Node B 12) may analyze the primary control channel (e.g., primary E-DPCCH) and the secondary control channel (e.g., secondary E-DPCCH) to determine whether the UE is communicating on the primary and secondary control channels (e.g., primary and secondary E-DPCCHs).

In an example embodiment, the processor of the Node B may determine that the UE is communicating on the primary control channel (e.g., primary E-DPCCH) and the secondary control channel (e.g., secondary E-DPCCH) based in part on comparing an average power of the two control channels (e.g., two E-DPCCHs) to a predetermined threshold, as described more fully below. As such, in an instance in which the processor 24 of the Node B (e.g., Node B 12) detects data on the primary control channel (e.g., primary E-DPCCH) and the secondary (e.g., secondary E-DPCCH), the detection of the data may indicate to the Node B that data on both the primary and secondary data channels (e.g., primary and secondary E-DPDCHs) is transmitted. On the other hand, the processor (e.g., processor 24) of the Node B (e.g., Node B 12) may determine that the UE discontinued communications in an instance in which the processor does not detect or fails to detect communications from the UE on the primary and/or secondary control channels (e.g., primary and/or secondary E-DPCCHs).

In some example embodiments, in an instance in which a Node B generates a downlink grant indicating a preference for a dual stream transmission that is sent to a UE via signaling, the UE may decide to transmit a single stream transmission instead of the dual stream transmission. For purposes of illustration and not of limitation, the UE may determine to transmit a single stream transmission in an instance in which a processor (e.g., processor 34) of the UE (e.g., UE 10) determines that there is a small amount of data in a transmission buffer to send the Node B, for example. In this example embodiment, control information on the primary control channel (e.g., primary E-DPCCH) and the secondary control channel (e.g., secondary E-DPCCH) may be transmitted by the UE. However, the UE may transmit data on one primary data channel (e.g., a primary E-DPDCH). One primary data channel (e.g., a primary E-DPDCH) may be utilized by the UE to transmit data since the UE decided to perform a single stream transmission. As such, the Node B may perform single DTX detection using both the primary and secondary control channels (e.g., primary and secondary E-DPCCHs). However, the control information on the primary control channel (e.g., primary E-DPCCH) and the secondary control channel (e.g., secondary E-DPCCH) may indicate to the Node B that the UE transmits data on a single channel such as, for example, the primary data channel (e.g., the primary E-DPDCH).

In one example embodiment, in an instance in which a UE transmits primary and secondary control channels (e.g., primary and secondary E-DPCCHs) in response to receipt of a downlink grant indicating dual stream transmission from a Node B, the average received symbol power of the primary control channel (e.g., a primary E-DPCCH) may equal Pₚ and the average received symbol power of the secondary control channel (e.g., a secondary E-DPCCH) may equal Pₛ. The average power of both channels may be utilized by the processor (e.g., processor 24) of the Node B (e.g., Node B 12) for thresholding with the weighting factors Wₚ and Wₛ (e.g., a value of 0.5, etc.) for the primary control channel (e.g., a primary E-DPCCH) and the secondary control channel (e.g., a secondary E-DPCCH) respectively. As such, in an instance in which the processor (e.g., processor 24) of the Node B (e.g., Node B 12) determines that the condition WₚPₚ+WₛPₛ>Pₜₕᵣ is met, where Pₜₕᵣ is the decision threshold (also referred to herein as predetermined decision threshold or predetermined threshold power) is met, the processor of the Node B may determine that the primary and secondary control channels (e.g., primary and secondary E-DPCCHs) have been transmitted. On the other hand, in an instance in which the processor of the Node B determines that Pₜₕᵣ>WₚPₚ+WₛPₛ, the processor of the Node B may determine that the primary and secondary control channels (e.g., primary and secondary E-DPCCHs) are not transmitted/detected.

In an instance in which the UE transmits a single stream as a response to single stream downlink grant, the processor of the Node B may determine whether Pₚ>Pₜₕᵣ. In an instance in which the processor of the Node B determines that Pₚ>Pₜₕᵣ, the processor of the Node B may determine that the primary control channel (e.g., primary E-DPCCH) has been transmitted. On the other hand, in an instance in which the processor of the Node B determines that Pₜₕᵣ>Pₚ, the processor of the Node B may determine that the primary control channel (e.g., primary E-DPCCH) channel is not transmitted/detected.

In an example embodiment, the weighting factors Wₚ and Wₛ may be adjusted by the processor (e.g., processor 24) of the Node B (e.g., Node B 12) based in part on: (1) a received signal-to-interference-and-noise ratio (SINR) of the primary (p) E-DPCCH and the secondary(s) E-DPCCH, respectively; (2) whether a secondary E-DPCCH (S-E-DPCCH) is precoded with a primary weight vector or a secondary weight vector; (3) one or more gain factors applied for the primary E-DPCCH and/or the secondary E-DPCCH; or (4) any other suitable factors or criteria.

In an example embodiment, a number of preferred data streams may be derived by the processor (e.g., processor 34) of a UE (e.g., UE 10) based in part on the granted power indicated in a downlink grant by a Node B or a reported UE power headroom (UPH) with an implicit mapping in an instance in which there is no rank information indicated in the downlink grant signaling by the Node B. For example, by following a mapping, a dual stream may be transmitted in an instance in which the granted power is above a certain threshold and the UE transmitted power is below the maximum allowed transmission power by a certain amount (e.g., UPH is higher than a certain threshold).

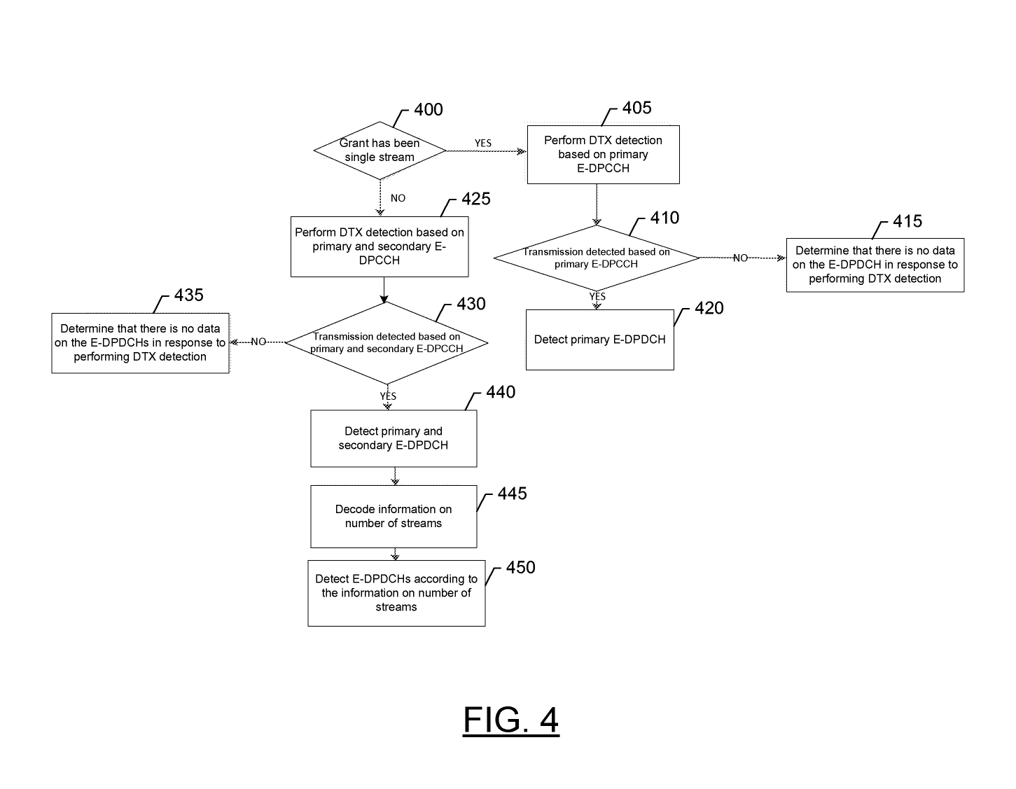

Referring now to FIG. 4, an exemplary method for detecting a number of transmitted streams on an E-DPDCH based in part on a grant is provided according to an example embodiment. At operation 400, an apparatus (e.g., Node B 12) may generate a grant indicating a preference for a single or dual stream transmission(s) and may provide the grant to a UE (e.g., UE 10). At operation 405, an apparatus (e.g., Node B 12) may perform DTX detection based in part on analyzing a primary E-DPCCH in response to determining that the grant indicates to the UE to communicate with a single stream transmission. At operation 410, an apparatus (e.g., Node B 12) may determine whether a transmission is detected based in part on analyzing the primary E-DPCCH. At operation 415, an apparatus (e.g., Node B 12) may determine that there is no data on the E-DPDCH expected in response to determining that a UE discontinued communications on the primary E-DPCCH. At operation 420, an apparatus (e.g., Node B) may detect data on the E-DPDCH in response to detecting communications on the primary E-DPCCH.

At operation 425, an apparatus (e.g., Node B 12) may perform DTX detection based in part on analyzing the primary E-DPCCH and the secondary E-DPCCH in response to a UE (e.g., UE 12) transmitting dual streams in an instance in which the apparatus provides a grant to the UE indicating a preference for dual stream transmissions. At operation 430, an apparatus may determine whether a transmission(s) or communication(s) is detected based on analyzing the primary E-DPCCH and the secondary E-DPCCH during the DTX detection. At operation 435, an apparatus (e.g., Node B 12) may determine that there is no data on the E-DPDCH expected in response to detecting that communications on the primary E-DPCCH and the secondary E-DPCCH are discontinued by the UE.

At operation 440, an apparatus (e.g., Node B 12) may detect data on the primary E-DPDCH and the secondary E-DPDCH in response to detecting a transmission(s) or communication(s) on the primary E-DPCCH and the secondary E-DPCCH. At operation 445, an apparatus (e.g., Node B 12) may decode the information associated with the number of streams (e.g., the dual streams) from the primary and secondary E-DPCCH data. At operation 450, an apparatus (e.g., Node B) may detect E-DPDCHs according to the information on the number of streams.

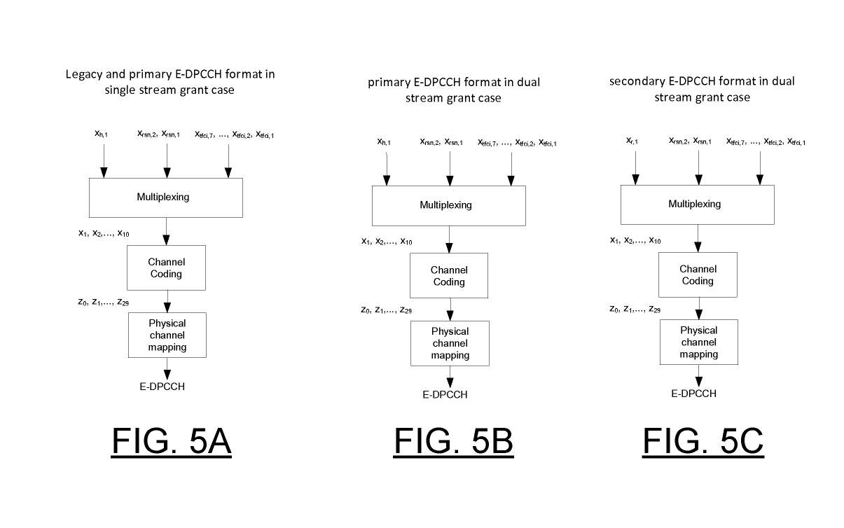

Referring now to FIGS. 5A, 5B and 5C, diagrams of a single stream E-DPCCH format and dual stream E-DPCCH formats are provided according to an exemplary embodiment. In the example embodiment of FIG. 5A, an E-DPCCH format for a single stream transmission that the UE may generate in response to receiving a grant from a Node B indicating a preference for single stream transmission(s) is provided. As shown in FIG. 5A, a happy bit, x_{h,1}, one or more Retransmission Sequence Number (RSN) bits, x_{rsn,2}, x_{rsn,1} and one or more E-TCFI bits, x_{tfci,7}, . . . , x_{tfci2}, x_{tfci,1} are multiplexed and subsequently channel coded. The output of the channel coding is utilized by a processor (e.g., processor 34) of a UE (e.g., UE 10) and output as the format for a primary E-DPCCH for a single stream transmission.

Referring now to FIGS. 5B and 5C, diagrams are provided illustrating a primary E-DPCCH format and a secondary E-DPCCH format for a dual stream transmission. The primary E-DPCCH and the secondary E-DPCCH may be transmitted by a UE (e.g., UE 10) in response to receiving a grant from a Node B (e.g., Node B 12) indicating a preference for dual stream transmissions. In the example embodiment of FIG. 5B, the UE may include a happy bit(s) x_{h,1} in the primary E-DPCCH. The happy bit(s) (e.g., x_{h,1}) may be multiplexed with RSN bits (e.g., x_{rsn,2}, x_{rsn,1}) and one or more E-TCFI bits (e.g., x_{tfci,7}, . . . , x_{tfci2}, x_{tfci,1}). The multiplexed bits may be channel coded by a processor (e.g., processor 34) of the UE, and the processor of the UE may subsequently map the channel coded bits on the primary E-DPCCH.

In the example embodiment of the FIG. 5C, the UE may replace the happy bit(s) with a rank indicator bit(s), x_{r,1}, in the secondary E-DPCCH. In an example embodiment, the rank indicator bit(s) may indicate the number of data channels that the UE is communicating on or transmitting. For example, in an instance in which the processor (e.g., processor 34) of the UE (e.g., UE 10) denotes that the rank indicator bit x_{r,1}=0, the rank indicator bit may indicate that the UE communicates on/transmits the primary E-DPDCH. However, in an instance in which the processor of the UE denotes that the rank indicator bit(s) x_{r,1}=1, the rank indicator bit may indicate that the primary E-DPDCH and the secondary E-DPDCH are communicated on/transmitted by the UE.

The rank indicator bit(s) (e.g., x_{r,1}) may be multiplexed with one or more RSN bits (e.g., x_{rsn,2}, x_{rsn,1}) and one or more E-TCFI bits (e.g., x_{tfci,7}, . . . , x_{tfci2}, x_{tfci,1}). The multiplexed bits may be channel coded by a processor (e.g., processor 34) of the UE (e.g., UE 10), and the processor of the UE may subsequently map the channel coded bits on the secondary E-DPCCH.

In one example embodiment, in an instance in which the rank indicator bit is detected to equal 0, at least a portion of the information on the secondary E-DPCCH may be omitted. The information that may be omitted may include, but is not limited to, one or more RSN bits, E-TCFI bits, etc. The processor of the UE may omit this information from the secondary E-DPCCH since the information may also be on the primary E-DPCCH. As such, by omitting the information on the secondary E-DPCCH, the processor of the UE may not encode the same information twice since this information may also be encoded in association with the primary E-DPCCH. In an alternative example embodiment, the processor of the UE may assign fixed values to the RSN bits and/or the E-TCFI bits of the secondary E-DPCCH to generate a known sequence in the secondary E-DPCCH for transmission. The known sequence may be utilized as a pilot signal(s). In this regard, for example, the one or more fixed values of the known sequence may be utilized for channel estimation of streams (e.g., dual streams), for example.

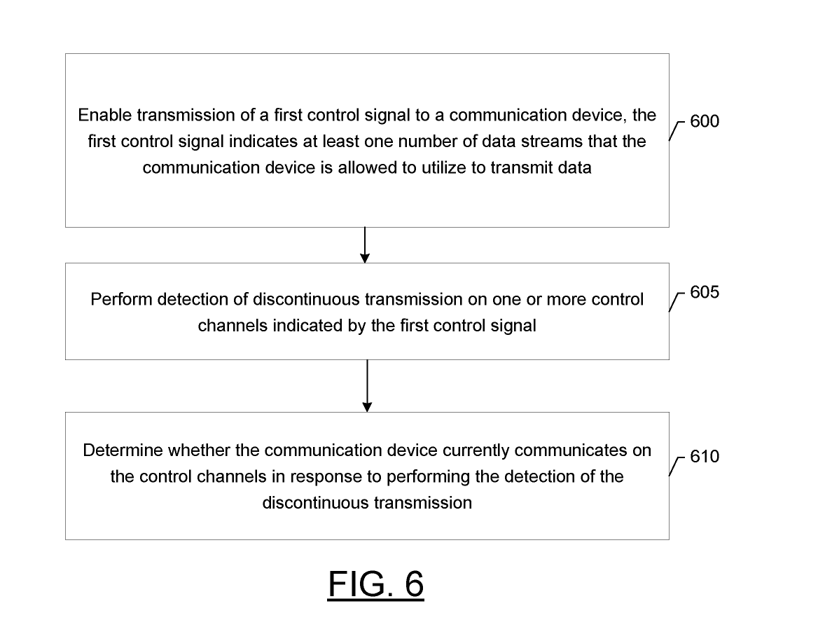

Referring now to FIG. 6, a flowchart is provided of an example method for detecting multiple input multiple output communications. In one example embodiment, the example method may be utilized for a high speed uplink packet access. At operation 600, an apparatus (e.g., Node B 12) may enable transmission of a first control signal (e.g., a grant) to a communication device (e.g., a UE 10). The first control signal may indicate at least one number of data streams (e.g., a single data stream or a dual data stream) that the communication device is allowed to utilize to transmit data. At operation 605, an apparatus (e.g., Node B 12) may perform detection of discontinuous transmission on one or more control channels (e.g., primary and secondary E-DPCCHs) indicated by the first control signal. At operation 610, an apparatus (e.g., Node B 12) may determine whether the communication device (e.g., a UE 10) currently communicates on the control channels (e.g., a primary E-DPCCH and/or a secondary E-DPCCH) in response to performing the detection of the discontinuous transmission.

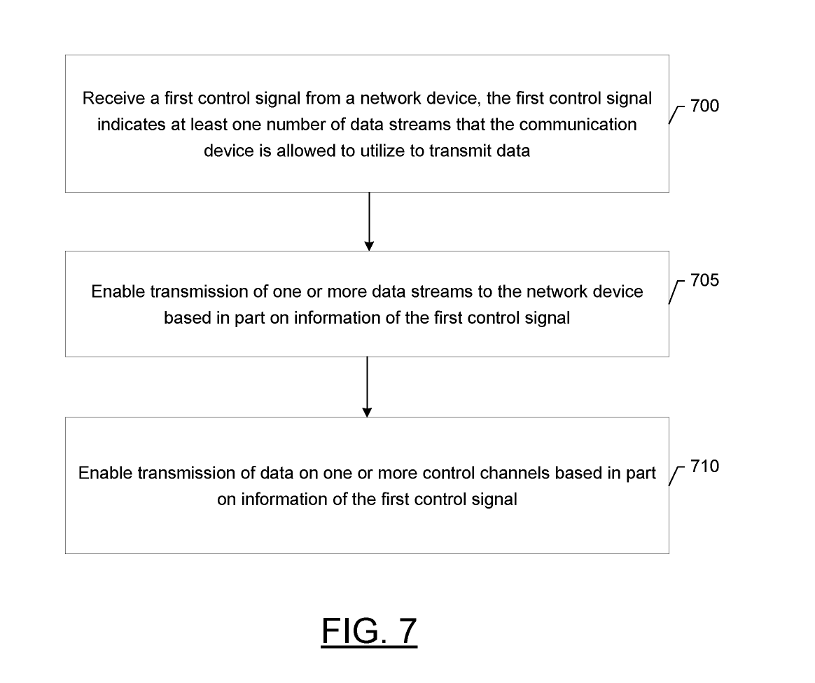

Referring now to FIG. 7, a flowchart is provided of an example method for facilitating multiple input multiple output communications. In one example embodiment, the method may be utilized for a high speed uplink packet access. At operation 700, an apparatus (e.g., UE 10) may receive a first control signal (e.g., a grant) from a network device (e.g., Node B 12). The first control signal may indicate at least one number of data streams (e.g., a single data stream or a dual data stream) that the apparatus is allowed to utilize to transmit data. At operation 705, an apparatus (e.g., UE 10) may enable transmission of one or more data streams to the network device (e.g., Node B 12) based in part on information of the first control signal. At operation 710, an apparatus (e.g., UE 10) may enable transmission of data on one or more control channels (e.g., primary and secondary E-DPCCHs) based in part on information of the first control signal.

It should be pointed out that FIGS. 6 and 7 are flowcharts of a system, method and computer program product according to an example embodiment of the invention. It will be understood that each block of the flowcharts, and combinations of blocks in the flowcharts, can be implemented by various means, such as hardware, firmware, and/or a computer program product including one or more computer program instructions. For example, one or more of the procedures described above may be embodied by computer program instructions. In this regard, in an example embodiment, the computer program instructions which embody the procedures described above are stored by a memory device (e.g., memory 26, memory 36) and executed by a processor (e.g., processor 24, processor 34). As will be appreciated, any such computer program instructions may be loaded onto a computer or other programmable apparatus (e.g., hardware) to produce a machine, such that the instructions which execute on the computer or other programmable apparatus cause the functions specified in the flowcharts blocks to be implemented. In one embodiment, the computer program instructions are stored in a computer-readable memory that can direct a computer or other programmable apparatus to function in a particular manner, such that the instructions stored in the computer-readable memory produce an article of manufacture including instructions which implement the function(s) specified in the flowcharts blocks. The computer program instructions may also be loaded onto a computer or other programmable apparatus to cause a series of operations to be performed on the computer or other programmable apparatus to produce a computer-implemented process such that the instructions which execute on the computer or other programmable apparatus implement the functions specified in the flowcharts blocks.

Accordingly, blocks of the flowcharts support combinations of means for performing the specified functions. It will also be understood that one or more blocks of the flowcharts, and combinations of blocks in the flowcharts, can be implemented by special purpose hardware-based computer systems which perform the specified functions, or combinations of special purpose hardware and computer instructions.

In an example embodiment, an apparatus for performing the methods of FIGS. 6 and 7 above may comprise a processor (e.g., the processor 24, processor 34) configured to perform some or each of the operations (600-610, 700-710) described above. The processor may, for example, be configured to perform the operations (600-610, 700-710) by performing hardware implemented logical functions, executing stored instructions, or executing algorithms for performing each of the operations. Alternatively, the apparatus may comprise means for performing each of the operations described above. In this regard, according to an example embodiment, examples of means for performing operations (600-610, 700-710) may comprise, for example, the processor 24 (e.g., as means for performing any of the operations described above), the processor 34 and/or a device or circuitry for executing instructions or executing an algorithm for processing information as described above.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

That which is claimed:

1. A method for detecting multiple input multiple output communications comprising:
enabling transmission of a first control signal to a communication device, the first control signal indicating at least one number of data streams that the communication device is allowed to utilize to transmit data;
performing detection of discontinuous transmission on one or more control channels indicated by the first control signal; and
determining, via a processor, whether the communication device currently communicates on the control channels in response to performing the detection of discontinuous transmission.

2. The method of claim 1, wherein the control channels comprises enhanced dedicated physical control channels.

3. The method of claim 1, wherein the first control signal comprises a downlink grant message of a high speed uplink packet access.

4. The method of claim 1, wherein information of the first control signal indicates that the data stream comprises a dual data stream and the method further comprises:
detecting that the communication device transmits at least one item of control information on a primary enhanced dedicated control channel and a secondary enhanced dedicated control channel of the control channels in response to performing the detection of the discontinuous transmission.

5. The method of claim 1, wherein information of the first control signal indicates that the data stream comprises a dual data stream and wherein:
performing further comprises performing detection of the discontinuous transmission on a primary enhanced dedicated control channel and a secondary enhanced dedicated control channel of the control channels.

6. The method of claim 1, wherein information of the first control signal indicates that the data stream comprises a dual data stream and the method further comprises:
detecting that the communication device transmits data on a primary enhanced dedicated data channel, among a plurality of enhanced dedicated data channels, in response to determining that the communication device currently communicates a single data stream although the first control signal specifies a preference for the communication device to utilize the dual data stream to communicate information.

7. The method of claim 6, further comprising:
detecting that the communication device transmits data on the primary enhanced dedicated data channel in response to identifying data on the primary enhanced dedicated control channel and a secondary enhanced dedicated control channel of the control channels indicating that the communication device transmits data on the primary enhanced dedicated data channel.

8. An apparatus for detecting multiple input multiple output communications comprising:
at least one processor; and
at least one memory including computer program code configured to, with the at least one processor, cause the apparatus to perform at least the following:
enable transmission of a first control signal to a communication device, the first control signal indicating at least one number of data streams that the communication device is allowed to utilize to transmit data;
perform detection of discontinuous transmission on one or more control channels indicated by the first control signal; and
determine whether the communication device currently communicates on the control channels in response to performing the detection of discontinuous transmission.

9. The apparatus of claim 8, wherein the control channels comprises enhanced dedicated physical control channels.

10. The apparatus of claim 8, wherein:
the first control signal comprises a downlink grant message of a high speed uplink packet access; and
the apparatus comprises a base station.

11. The apparatus of claim 8, wherein information of the first control signal indicates that the data stream comprises a dual data stream and wherein the memory and computer program code are configured to, with the processor, cause the apparatus to:
detect that the communication device transmits at least one item of control information on a primary enhanced dedicated control channel and a secondary enhanced dedicated control channel of the control channels in response to performing the detection of the discontinuous transmission.

12. The apparatus of claim 8, wherein information of the first control signal indicates that the data stream comprises a dual data stream and wherein the memory and computer program code are configured to, with the processor, cause the apparatus to:
perform the detection of the discontinuous transmission by performing the detection of the discontinuous transmission on a primary enhanced dedicated control channel and a secondary enhanced dedicated control channel of the control channels.

13. The apparatus of claim 8, wherein information of the first control signal indicates that the data stream comprises a dual data stream and wherein the memory and computer program code are configured to, with the processor, cause the apparatus to:
detect that the communication device transmits data on a primary enhanced dedicated data channel, among a plurality of enhanced dedicated data channels, in response to determining that the communication device currently communicates a single data stream although the first control signal specifies a preference for the communication device to utilize the dual data stream to communicate information.

14. The apparatus of claim 13, wherein the memory and computer program code are configured to, with the processor, cause the apparatus to:
detect that the communication device transmits data on the primary enhanced dedicated data channel in response to identifying data on a primary dedicated control channel and a secondary enhanced dedicated control channel of the control channels indicating that the communication device transmits data on the primary enhanced dedicated data channel.

15. An apparatus for facilitating multiple input multiple output communications comprising:
at least one processor; and
at least one memory including computer program code configured to, with the at least one processor, cause the apparatus to perform at least the following:
receive a first control signal from a network device, the first control signal indicating at least one number of data streams that the apparatus is allowed to utilize to transmit data;
enable transmission of one or more data streams to the network device based in part on information of the first control signal; and
enable transmission of data on one or more control channels based in part on the information of the first control signal.

16. The apparatus of claim 15, wherein:
the control channels comprises enhanced dedicated physical control channels; and
the apparatus comprises a mobile terminal.

17. The apparatus of claim 15, wherein the first control signal comprises a downlink grant message of a high speed uplink packet access.

18. The apparatus of claim 15, wherein the memory and computer program code are configured to, with the processor, cause the apparatus to:
enable transmission of one or more items of control information on a primary enhanced dedicated control channel and a secondary enhanced dedicated control channel of the control channels in response to determining that the first control signal indicates a preference to utilize the dual data stream.

19. The apparatus of claim 15, wherein the memory and computer program code are configured to, with the processor, cause the apparatus to:
include information on a primary enhanced dedicated control channel and a secondary enhanced dedicated control channel of the channels indicating that data is being transmitted on a primary enhanced dedicated data channel, among a plurality of enhanced dedicated data channels, in response to causing transmission of the single data stream even though the network device indicated the preference to utilize the dual data stream.

20. The apparatus of claim 15, wherein the memory and computer program code are configured to, with the processor, cause the apparatus to:
include information on a primary enhanced dedicated control channel and a secondary enhanced dedicated control channel of the control channels indicating that data is being transmitted on a primary enhanced dedicated data channel and a secondary enhanced dedicated data channel, among the enhanced dedicated data channels, in response to causing transmission of the dual data stream based in part on the indicated preference to utilize the dual data stream.
